(19) United States
(12) Patent Application Publication
(10) Pub. No.: US 2025/0192339 A1
(43) Pub. Date: Jun. 12, 2025

(54) BATTERY PACK

(71) Applicant: TOYOTA JIDOSHA KABUSHIKI KAISHA, Toyota-shi (JP)

(72) Inventors: Kensuke MATSUO, Seto-shi (JP); Shigeyuki INOUE, Toyota-shi (JP)

(73) Assignee: TOYOTA JIDOSHA KABUSHIKI KAISHA, Toyota-shi (JP)

(21) Appl. No.: 18/820,549

(22) Filed: Aug. 30, 2024

(30) Foreign Application Priority Data
Dec. 6, 2023 (JP) 2023-206324

(51) Int. Cl. H01M 50/317; H01M 50/204; H01M 50/242; H01M 50/367

(52) U.S. Cl. CPC H01M 50/317; H01M 50/204; H01M 50/242; H01M 50/367; H01M 2200/20

(57) ABSTRACT

A battery pack includes a battery module including a plurality of battery cells each having a safety valve to open when an internal pressure of the battery cell increases, the battery cells being stacked; a case housing the battery modules; an exhaust passage provided, along a first direction, at a position facing the safety valves in the case in a second direction; and a sealing member provided between the case and the battery module and arranged around the exhaust passage to define the exhaust passage.

### CROSS-REFERENCE TO RELATED APPLICATION

This application claims priority to Japanese Patent Application No. 2023-206324 filed on Dec. 6, 2023, incorporated herein by reference in its entirety.

### BACKGROUND

### 1. Technical Field

The present disclosure relates to a battery pack.

### 2. Description of Related Art

Japanese Unexamined Patent Application Publication No. 2023-017448 (JP 2023-017448 A) discloses a battery pack including a plurality of stacked battery cells and an exhaust duct through which a gas released from the battery cells flows. Each of the battery cells has an exhaust valve. The internal space of the exhaust duct forms a smoke exhaust passage.

### SUMMARY

In JP 2023-017448 A, a spouting object released from the exhaust valves flows through the exhaust duct. Consequently, if the exhaust duct is small, the exhaust passage might be clogged when a large amount of spouting object is released. Furthermore, the number of components increases because the exhaust duct needs to be disposed on a top of a resin frame.

The present disclosure provides a battery pack that can release a spouting object to the outside with a simple configuration.

A battery pack according to one aspect of the present disclosure includes: a battery module including a plurality of battery cells each having a safety valve to open when an internal pressure of the battery cell increases, the battery cells being stacked in a first direction; a case housing the battery module; an exhaust passage provided in the case along the first direction and arranged at a position facing the safety valves in a second direction; and a sealing member provided between the case and the battery module and arranged around the exhaust passage to define the exhaust passage.

According to the present disclosure, it is possible to provide a battery pack capable of releasing a spouting object to the outside with a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a top view schematically showing a configuration of a battery pack;

FIG. 2 is an xz-sectional view schematically showing the configuration of the battery pack;

FIG. 3 is a yz-sectional view schematically showing the configuration of the battery pack;

FIG. 4 is an xz-sectional view schematically showing a configuration of a battery pack of a modification;

FIG. 5 is an xz-sectional view schematically showing a configuration of a battery pack of a structural example 1; and

FIG. 6 is an xz-sectional view schematically showing a configuration of a battery pack of a structural example 2.

### DETAILED DESCRIPTION OF EMBODIMENTS

Specific embodiments of the present disclosure will be described in detail below with reference to the drawings. However, the present disclosure is not limited to the following embodiments. In order to clarify the description, the following description and drawings are simplified as appropriate.

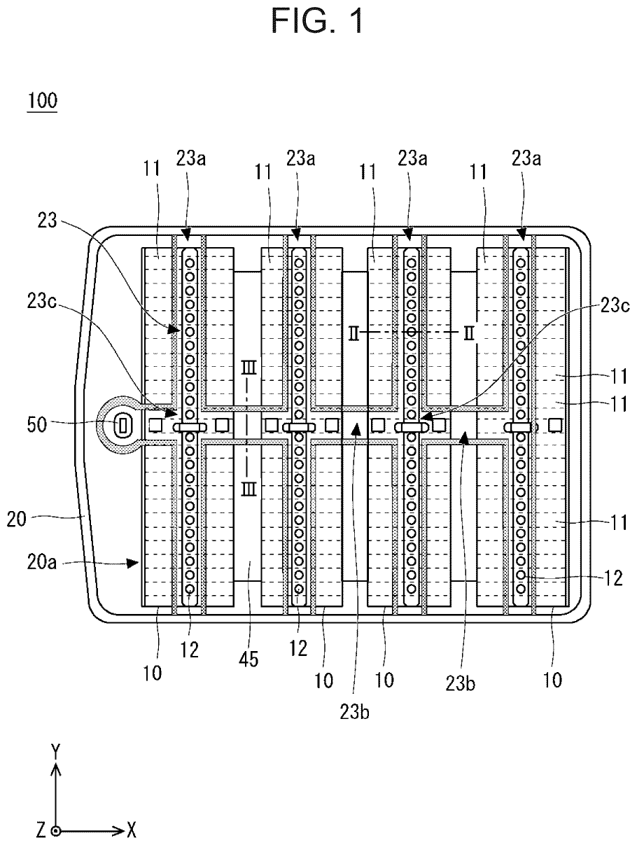

First, a battery pack 100 will be described with reference to FIG. 1. FIG. 1 is a top view schematically showing the configuration of the battery pack 100. For clarity of explanation, an xyz three-dimensional Cartesian coordinate system is used in the drawings. Usually, the +z-axis positive direction is a perpendicularly upward direction and the xy-plane is a horizontal plane. The y-direction is a stacking direction of a plurality of battery cells. In other words, in a battery module, the plurality of battery cells is stacked in the y-direction. The height direction or the like are relative directions and are appropriately changed depending on the orientation of the battery pack 100.

The battery pack 100 includes a case 20 and battery modules 10. In the xy-plane view, the case 20 includes an almost rectangular-shaped case body and houses the battery modules 10. As described below, the case 20 is separated into an upper case and a lower case; therefore, the upper case is omitted in FIG. 1. In FIG. 1, four battery modules 10 are housed in the case 20. The four battery modules 10 have almost the same size and are arranged side by side in the y-direction. In the case 20, the space housing the battery modules 10 is defined as a housing space 20a.

The battery module 10 includes a plurality of battery cells 11. The battery cells 11 are secondary batteries such as lithium-ion batteries or nickel metal hydride batteries. Each battery cell 11 is a rectangular battery having a substantially rectangular shape in the xz-plane. An electrode body is housed inside a cell case of the battery cell 11. The electrode body is formed, for example, by stacking positive electrodes and negative electrodes with separators disposed therebetween, and further winding them into a cylindrical shape. The type of the electrode body is not limited to the wound type but may also be the stacked type. The electrode body is immersed with electrolyte. Positive and negative electrode terminals (not shown) are taken out from a top surface or a side surface of each battery cell 11. In each battery module 10, the terminals of the plurality of battery cells 11 are connected by busbars (not shown).

As described above, in each battery module 10, the plurality of battery cells 11 are stacked in the y-direction. Each of the battery cells 11 has a safety valve 12. The safety valve 12 opens when an internal pressure of the battery cell 11 increases. In other words, when gas or smoke (hereinafter, collectively referred to as a spouting object) is generated from the battery cell 11, the pressure in the internal space of the battery cell 11 increases. When the pressure in the internal space increases, the safety valve 12 opens to release the spouting object in the internal space to the outside of the battery cell 11. Accordingly, the safety is enhanced.

Each of the battery cells 11 has the safety valve 12. The safety valve 12 is formed on the top surface of the battery cell 11. In one battery module 10, a plurality of safety valves 12 are side by side in a row. Specifically, in each battery module 10, the plurality of safety valves 12 are arranged in one row along the y-direction. In this case, since four battery modules 10 are provided, the safety valves 12 are arranged in four rows. In each battery module 10, the safety valves 12 are arranged at the center of the battery module 10 in the x-direction.

The safety valves 12 are connected to exhaust passages 23 provided in the case 20. In other words, the exhaust passages 23 are disposed at positions facing the safety valves 12 in the case 20. The exhaust passages 23 include first passages 23a provided along the y-direction, and a second passage 23b provided along the x-direction. Intersections of the first passages 23a and the second passage 23b are defined as intersections 23c.

Each first passage 23a is a part arranged directly above each row of the safety valves 12. In this case, four battery modules 10 are provided; therefore, there are four rows of the first passages 23a. Each first passage 23a is arranged at the center of the battery module 10 in the x-direction. The second passage 23b connects the plurality of first passages 23a to an exhaust valve 50. The second passage 23b is formed to intersect the plurality of first passages 23a along the x-direction. The second passage 23b is arranged at the centers of the first passages 23a in the y-direction.

The spouting object released from the safety valves 12 passes through the first passages 23a and the second passage 23b, to reach the exhaust valve 50. As a result, the exhaust valve 50 can release the spouting object to the outside of the case. Accordingly, increase in pressure inside the case 20 can be reduced. The exhaust valve 50 acts as a smoke exhaust valve to exhaust smoke generated from the battery cells 11. The exhaust valve 50 may be a safety valve to open when the internal pressure of the case 20 increases. An exhaust port may be provided, instead of the exhaust valve 50.

A cushioning member 45 is arranged between each two adjacent battery modules 10. In other words, each two adjacent battery modules 10 face each other via the cushioning member 45. The cushioning member 45 is a plate-shaped member and is formed of an elastic resin or the like. Accordingly, it is possible to reduce an impact applied to the battery modules 10.

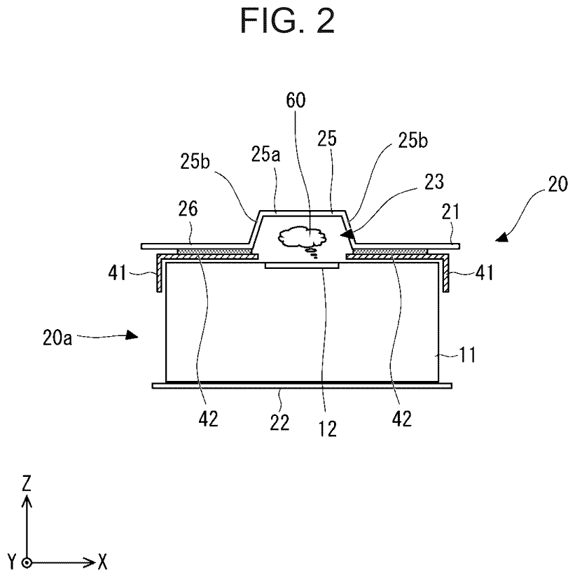

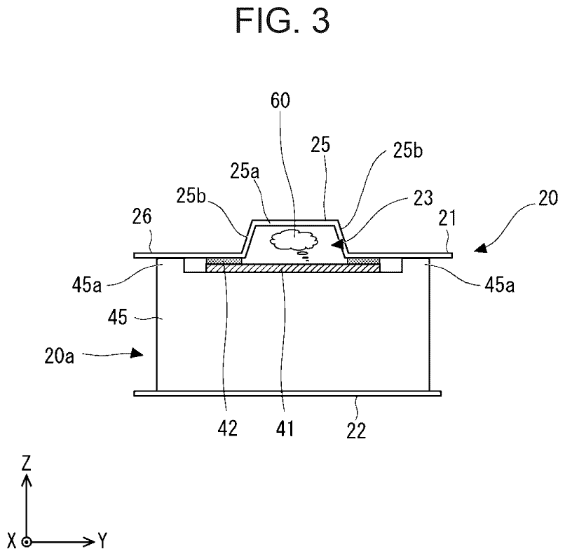

The configuration of the exhaust passages 23 and surroundings thereof will be described using FIG. 2 and FIG. 3. FIG. 2 is a sectional view taken along line II-II of FIG. 1, showing the configuration in the xz-plane. FIG. 3 is a sectional view taken along line III-III of FIG. 1, showing the configuration in the yz-plane.

The case 20 includes a first case 21 and a second case 22. The first case 21 is an upper case (UPR case) located on the upper side of the battery cells 11. The second case 22 is a lower case (LWR case) located on the lower side of the battery cells 11. The second case 22 has a box-like shape opening upward. The first case 21 has a box-like shape opening downward. The first case 21 serves as a lid that covers the upper side of the second case 22.

The first case 21 and the second case 22 are formed of metallic material, for example. For example, the first case 21 and the second case 22 are formed by pressing a metal sheet or the like. With the battery modules 10 placed inside the second case 22, the second case 22 is covered by the first case 21 from above, and thereby house the battery modules 10 in the case 20. After the battery modules 10 are housed in the case 20, the first case 21 and the second case 22 may be fixed together by welding or the like.

The first case 21 has protrusions 25 protruding upwards. The protrusions 25 are located directly above the safety valves 12 and define the exhaust passages 23. The space located below each protrusion 25 forms each exhaust passage 23. In the xy-plane view, each protrusion 25 faces the safety valves 12. The protrusions 25 protrude in a direction away from the battery cells 11. For example, the first case 21 can be formed with the protrusions 25 by pressing a metal sheet.

More specifically, the protrusion 25 has a facing part 25a and an inclined part 25b. The facing part 25a includes a surface parallel to the xy-plane, and the inclined part 25b includes surfaces inclined relative to the xy-plane. In the first case 21, an outer part of the protrusion 25 is defined as a holding part 26. The holding part 26 includes surfaces parallel to the xy-plane, serving as surfaces holding the battery module 10.

In the first passage 23a, the facing part 25a is located at a position facing the row of the safety valves 12. The inclined part 25b serves as the surfaces that connect the facing part 25a and the holding part 26. Thus, the inclined part 25b is formed on both sides of the facing part 25a. The inclined part 25b includes tapered surfaces extending in the +z-direction from the holding part 26 toward the facing part 25a. Therefore, the facing part 25a is located on the +z-side from the holding part 26.

By providing the protrusions 25, the exhaust passages 23 can be made larger. Accordingly, the exhaust passages 23 can be prevented from being clogged even when a large amount of the spouting object 60 is released. This allows the spouting object 60 to be released efficiently to the outside, thereby improving the safety. The protrusions 25 can be formed by processing a metal sheet. Therefore, the protrusions 25 act as ribs that enhance the rigidity of the first case 21. Accordingly, a thinner metal sheet can be used for the purpose of reduction in weight. Furthermore, the exhaust passages 23 can be secured without increasing the number of separate components. It is possible to reduce increase in number of components. Accordingly, the exhaust passages 23 can be formed in a simple configuration, thereby reducing the component costs.

A sealing member 42 and a mica member 41 are arranged between the first case 21 and the battery cells 11. The sealing member 42 is arranged between the mica member 41 and the first case 21. The sealing member 42 is, for example, an elastic member. The sealing member 42 may also be an adhesive material. For example, the sealing member 42 may be a double-sided adhesive tape that is elastic in the thickness direction. The mica member 41 is formed of a mica material excellent in insulation and heat resistance. That is, the mica member 41 serves as an insulating material excellent in heat resistance.

The sealing member 42 is in contact with the first case 21. The sealing member 42 is also arranged to be in contact with the mica member 41. Thus, the scaling member 42 can define the exhaust passage 23 formed by the protrusion 25. The scaling member 42 is arranged around the exhaust passage 23 to define the exhaust passage 23. That is, the exhaust passage 23 is defined to be separate from the housing space 20a.

Specifically, the sealing member 42 is arranged outward of the protrusions 25 and surrounds the exhaust passages 23. As shown in FIG. 2, the sealing member 42 is arranged on both sides in the x-direction of each protrusion 25 serving as the first passage 23a. Similarly, as shown in FIG. 3, the sealing member 42 is arranged on both sides in the y-direction of each protrusion 25 serving as the second passage 23b. The sealing member 42 is in contact with the holding parts 26. The sealing member 42 seals the gap between the mica member 41 and the holding parts 26. This allows the exhaust passages 23 to be separated from the housing space 20a, thereby preventing the spouting object from the safety valves 12 from entering the housing space 20a in the case 20. Accordingly, the spouting object can be efficiently released from the exhaust valve 50.

The distance between the facing part 25a and the battery module 10 can be increased by providing the protrusion 25. In other words, since the distance from the safety valves 12 to the facing part 25a can be increased, it is possible to prevent damages to the first case 21 caused by the spouting object 60.

As shown in FIG. 2, in the xz-plane view, the mica member 41 is formed in an L-shape to cover the top surfaces and the side surfaces of the battery cells 11. That is, the mica member 41 is bent to extend from the top surfaces to the side surfaces of the battery cells 11. The mica member 41 is arranged outside the parts corresponding to the first passages 23a. The sealing member 42 is in contact with the mica member 41. The mica member 41 is arranged immediately below the second passage 23b, as shown in FIG. 3. The mica member 41 is in contact with the cushioning member 45.

The cushioning member 45 has ridges 45a projecting toward the first case 21. As shown in FIG. 3, the cushioning member 45 has two ridges 45a. These two ridges 45a are arranged apart from each other in the y-direction. The second passage 23b is arranged between each two ridges 45a.

The ridges 45a are provided in contact with the holding part 26. Even when a load is applied to the first case 21 from above, deformation of the first case 21 can be prevented, thereby preventing the exhaust passages 23 from being clogged.

The first passages 23a for the plurality of battery modules 10 are communicated to the exhaust valve 50 via the second passage 23b. Therefore, the opening of the exhaust valve can be controlled by the pressure in the exhaust passages 23. In other words, when the pressure in the exhaust passages 23 increases, the spouting object 60 can be released to the outside of the case 20. It is possible to exhaust the spouting object 60 more suitably.

### Modification

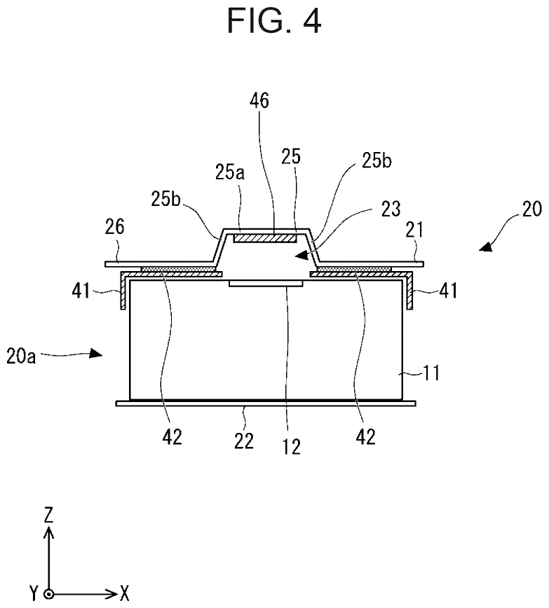

The configuration of the battery pack 100 according to a modification will be described with reference to FIG. 4. FIG. 4 is a sectional view showing the configuration of the first passage 23a and its surroundings in the battery pack 100. In FIG. 4, the battery pack 100 further includes an insulating member 46. The insulating member 46 is arranged at a position facing each exhaust passage 23 of the first case 21. Specifically, the insulating member 46 is an insulating sheet attached on each facing part 25a. Hence, the spouting object fuming from the safety valves 12 spouts against the insulating member 46.

For example, a fuming gas from the battery cells 11 might become a high temperature gas at 600° C. to 1000° C. Even when such a high temperature gas is generated, increase in temperature of the first case 21 can be reduced. Accordingly, the heat conduction of the first case 21 can prevent increase in temperature of the battery cells 11 other than the battery cells 11 whose safety valves are opened.

### Structural Example 1

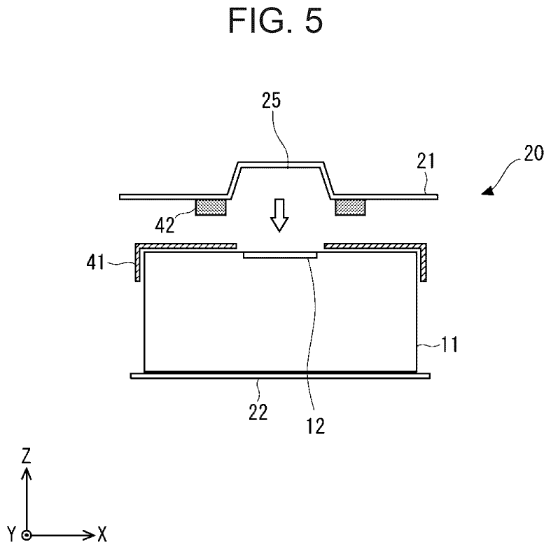

The structural example 1 of the sealing member 42 will be described with reference to FIG. 5. FIG. 5 is an xz-sectional view showing a configuration of the structural example 1. In the structural example 1, the sealing member 42 is bonded to the first case 21. Furthermore, the mica member 41 is attached to the battery cells 11. In other words, the sealing member 42 and the first case 21 are integrated before the battery modules 10 are housed. Then, the first case 21 integrated with the sealing member 42 is put on the battery cells 11 attached to the mica member 41 from above.

As the mica member 41 is attached to the battery cells 11, the high-voltage terminals of the battery cells 11 can be protected in advance. Thus, the safety during the assembly operation can be improved. In addition, a risk of adhesion of conductive foreign matters to the terminals can be reduced. An elastic material can be used for the sealing member 42. Hence, the sealing member 42 can be used as a cushioning member against an impact from upper side of the battery pack 100.

### Structural Example 2

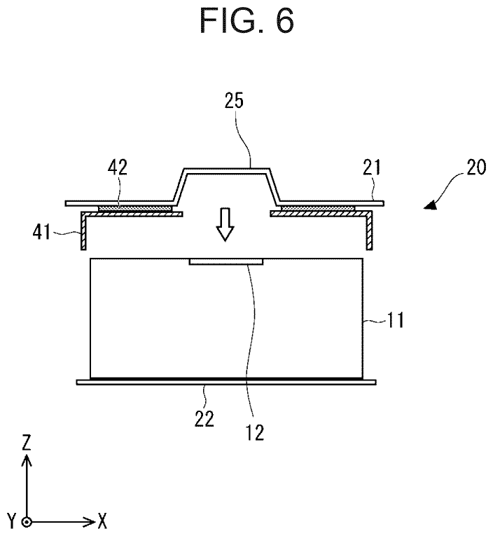

The structural example 2 of the sealing member 42 will be described with reference to FIG. 6. FIG. 6 is an xz-sectional view showing a configuration of the structural example 2. In FIG. 6, the first case 21, the sealing member 42, and the mica member 41 are integrated. For example, the sealing member 42 is a double-sided adhesive tape. Therefore, before the battery modules 10 are housed, the sealing member 42 can be integrated with the first case 21 and the mica member 41.

In the structural example 2, the operation of fixing the mica member 41 to the battery cells 11 can be omitted. In disassembly of the battery pack 100, the operation of removing the mica member 41 from the battery cells 11 can be reduced. Accordingly, the number of components and the number of processes can be reduced, thereby improving the productivity. Furthermore, the rigidity of the first case 21 can be enhanced by the mica member 41. Since it is unnecessary to consider positional variations between the mica member 41 and the first case 21, sealing leakage due to misalignment can be prevented.

Each exhaust passage 23 may be provided with a check valve. By providing the check valve, it is possible to prevent backflow of the spouting object from the safety valve. For example, the check valve may be provided at each of the intersections of the first passages 23a and the second passage 23b. This can prevent the spouting object from entering the first passages 23a for the battery modules 10 whose safety valves are not opened.

In addition, the exhaust passages 23 may be provided with rectifying fins. The rectifying fins are installed to allow the spouting object to flow toward the exhaust valve 50. For example, the rectifying fins may be disposed at the intersections of the first passages 23a and the second passage 23b. The rectifying fins preferably extend in the x-direction and are inclined toward the center of the battery modules 10 in the y-direction. Accordingly, it is possible to efficiently lead the spouting object to the exhaust valve 50.

The present disclosure is not limited to the above embodiments and can be modified as appropriate without departing from the spirit of the disclosure.

What is claimed is:

1. A battery pack comprising:
a battery module including a plurality of battery cells each having a safety valve to open when an internal pressure of the battery cell increases, the battery cells being stacked in a first direction;
a case housing the battery module;
an exhaust passage provided in the case along the first direction and arranged at a position facing the safety valves in a second direction; and
a sealing member provided between the case and the battery module and arranged around the exhaust passage to define the exhaust passage.

2. The battery pack according to claim 1, further comprising an insulating member disposed at a position facing the exhaust passage of the case.

3. The battery pack according to claim 1, wherein
the case includes a protrusion protruding in a direction away from the battery module, and
the sealing member is disposed outward of the protrusion such that the protrusion forms the exhaust passage.

4. The battery pack according to claim 1, wherein
the case further includes an exhaust valve connected to the exhaust passage,
the multiple battery modules are arranged side by side in a row in a third direction, and
the exhaust passage includes:
a plurality of first passages disposed in the first direction, one of the first passages being arranged to face the safety valves of the battery cells included in each battery module; and
a second passage disposed in the third direction and connecting the plurality of first passages to the exhaust valve.

5. The battery pack according to claim 4, wherein
the battery modules are provided,
a cushioning member is disposed between adjacent battery modules, and
the cushioning member includes a ridge that is located outward of the second passage and projects toward the case to abut on the case.
